(19) United States
(12) Patent Application Publication
(10) Pub. No.: US 2021/0079723 A1
(43) Pub. Date: Mar. 18, 2021

(54) RIVET STRINGING APPARATUS AND BLIND EQUIPPED WITH THE SAME

(71) Applicant: CHING FENG HOME FASHIONS CO., LTD., Fuxing Township (TW)

(72) Inventor: Wen-Ying LIANG, FUXING TOWNSHIP (TW)

(73) Assignee: CHING FENG HOME FASHIONS CO., LTD., Fuxing Township (TW)

(21) Appl. No.: 16/675,695

(22) Filed: Nov. 6, 2019

(30) Foreign Application Priority Data
Sep. 12, 2019 (TW) 108212153
Oct. 21, 2019 (TW) 108213837

(51) Int. Cl. E06B 9/322; E06B 9/327

(52) U.S. Cl. CPC E06B 9/322; E06B 9/327

(57) ABSTRACT

The blind includes an upper beam, a rope winder and a lifting rope. The bottom wall of the upper beam includes a through hole for the lifting rope to penetrate therethrough. The rope winder is arranged inside the upper beam and includes a top plate and a bottom plate. A winding wheel for winding the lifting rope is arranged between the top and bottom plates. The stringing apparatus of the present invention is arranged on the bottom wall of the upper beam and protrudes out of the top surface of the bottom wall. The relationship between a vertical distance from the bottom surface of the top plate of the rope winder to the top surface of the rope winder and a distance from the top surface of the stringing apparatus to the top surface of the bottom wall of the upper beam satisfies the relation of 2-5:1.

### BACKGROUND OF THE INVENTION

### 1. Technical Field

The present invention relates to a blind, in particular, to a stringing apparatus for a blind and a blind equipped with such stringing apparatus.

### 2. Description of Related Art

In general, as shown in FIG. 1, a blind without the exposure of pulling strings mainly utilizes a rope winder 92 installed inside the upper beam 90 to perform rolling and releasing of the two lifting ropes 95 on the left and right sides thereof. Since one ends of the two left and right lifting ropes 95 are attached onto the lower beam, the lower beam is able to gradually ascend during the rolling process of the two left and right lifting ropes 95, in order to achieve the collapsing effect of the blind through the upward movement of the lower beam.

Furthermore, the bottom wall 91 of the upper beam 90 is typically installed with a stringing apparatus 96 provided for the lifting ropes 95 for penetrating therethrough, such that the stringing apparatus 96 is able to provide the guiding effect to the lifting ropes 95, facilitating the releasing or winding process of the lifting ropes 95 to be smoother. Nevertheless, since the relative positions among a traditional stringing apparatus 96 and the top and bottom plates 93, 94 of the rope winder 92 are in a right triangle relationship (as shown in FIG. 2), when the rope winder 92 performs the winding of the lifting ropes 95 via the guidance of the traditional stringing member 96, different loops of the lifting ropes 95 tend to interfere with each other or even tangle with each other. If such situation is severe, then the issue of unsmoothness or jamming of the lifting ropes 95 during the release or winding process thereof occurs, causing the blind to have asymmetrical heights on two sides, and the blind may even fail to be fully deployed or collapsed, causing hassles to users.

### BRIEF SUMMARY OF THE INVENTION

The primary objective of the present invention is to provide a stringing apparatus for a blind, and it is able to allow the lifting rope to be wound smoothly and flatly, thereby achieving the effect of stable deployment and collapsing of the blind sheet of a blind.

To achieve the foregoing objective, the disclosed blind comprises an upper beam, a rope winder and a lifting rope. The upper beam includes a bottom wall, and the bottom wall includes a through hole provided for the lifting rope to penetrate therethrough. The rope winder is arranged inside the upper beam and includes a top plate, a bottom plate and a winding wheel arranged between the top plate and the bottom plate. One end of the lifting rope is arranged on the winding wheel in order to allow the lifting rope to be driven by the winding wheel in order to be wound at the winding wheel. The stringing apparatus is arranged on the bottom wall of the upper beam and protruded out of a top surface of the bottom wall of the upper beam, and the stringing apparatus further includes a circumferential wall, at least one assembly wing connected to the circumferential wall and a rope guiding hole provided for the lifting rope to penetrate therethrough. In addition, a vertical distance between a bottom surface of the top plate of the rope winder and a top surface of the bottom plate of the rope winder is defined as H₁, and a vertical distance between atop surface of the stringing apparatus and a top surface of the bottom wall of the upper beam is defined as H₂, and a relationship between the two distances satisfies a relation of H₁:H₂=2-5:1.

In view of the above, it can be understood that the stringing apparatus of the present invention utilizes the ratio relationship of height of the rope winder in order to allow the lifting rope to be stably and smoothly wound onto the winding wheel, such that no interference of tangling of ropes occurs among different loops of the rope, thereby achieving the effect of stable deployment and collapsing of the blind sheet of the blind.

More information about the configuration, features, assembly and uses of the stringing apparatus for a blind and a blind equipped with the same thereof of the present invention will be provided in the following description in detail. However, people skilled in the art shall appreciate that the detailed description and embodiments as well as aspects are for illustration only, and by no means intended to limit the scope of the present invention.

### BRIEF DESCRIPTION OF THE SEVERAL VIEWS OF THE DRAWINGS

FIG. 1 is a perspective view of a known stringing apparatus used in conjunction with a blind.

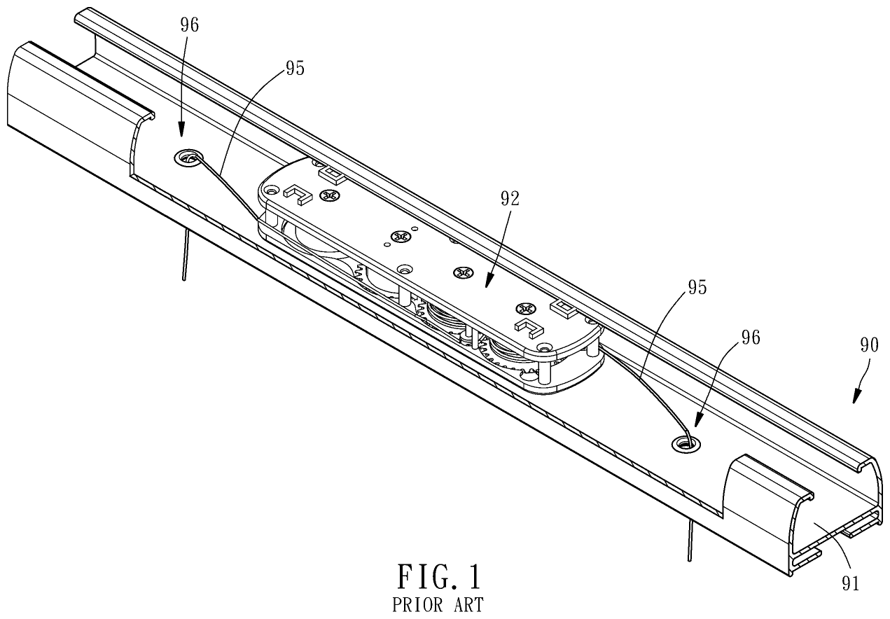

FIG. 2 is a front view of FIG. 1.

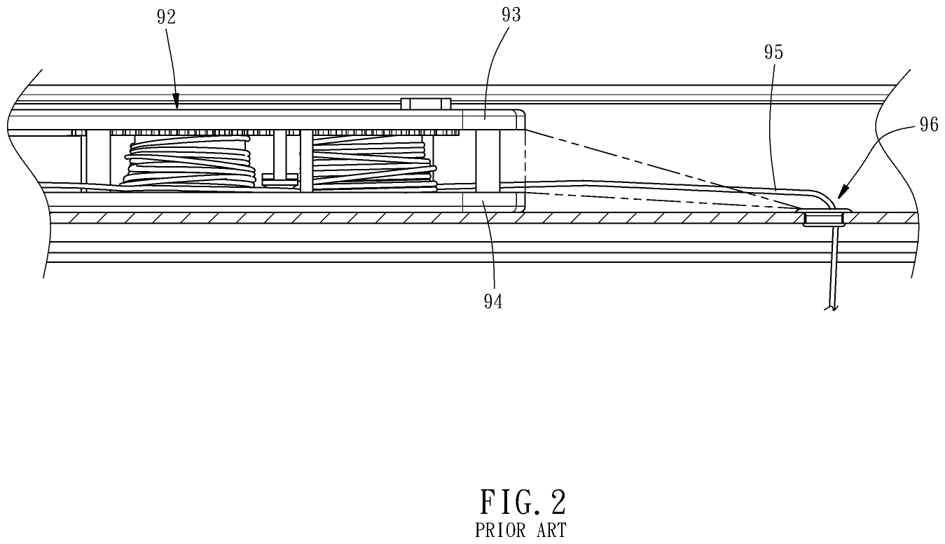

FIG. 3 is a perspective view of the stringing apparatus according to the first embodiment of the present invention used in conjunction with a blind.

FIG. 4 is similar to FIG. 3, and mainly illustrates the collapsing state of the blind sheet.

FIG. 5 is a perspective view of the stringing apparatus according to the first embodiment of the present invention.

FIG. 6A and FIG. 6B are schematic views illustrating the stringing apparatus according to the first embodiment of the present invention installed onto the upper beam.

FIG. 7 is a cross sectional view illustrating the stringing apparatus according to the first embodiment of the present invention assembled onto the upper beam.

FIG. 8 is a front view of the stringing apparatus according to the first embodiment of the present invention in conjunction with the use of the rope winder and the lifting rope, mainly illustrating the structural relationship between the stringing apparatus and the rope winder during the collapsing of the blind sheet.

FIG. 9 is similar to FIG. 8 mainly illustrating the structural relationship between the stringing apparatus and the rope winder during the deployment of the blind sheet.

FIG. 10 is front view of the stringing apparatus according to first embodiment of the present invention in conjunction with the rope winder, mainly illustrating the distance relationship between the circumferential wall of the stringing apparatus and the guiding rode of the rope winder.

### DETAILED DESCRIPTION OF THE INVENTION

The Applicant first emphasizes herein that in the entire specification, including embodiments and claims, terms related to directions shall be based on the direction illustrated in the drawings. In addition, in the embodiments and drawings disclosed in the following, identical or similar elements or features are identified by the same numbers throughout all figures.

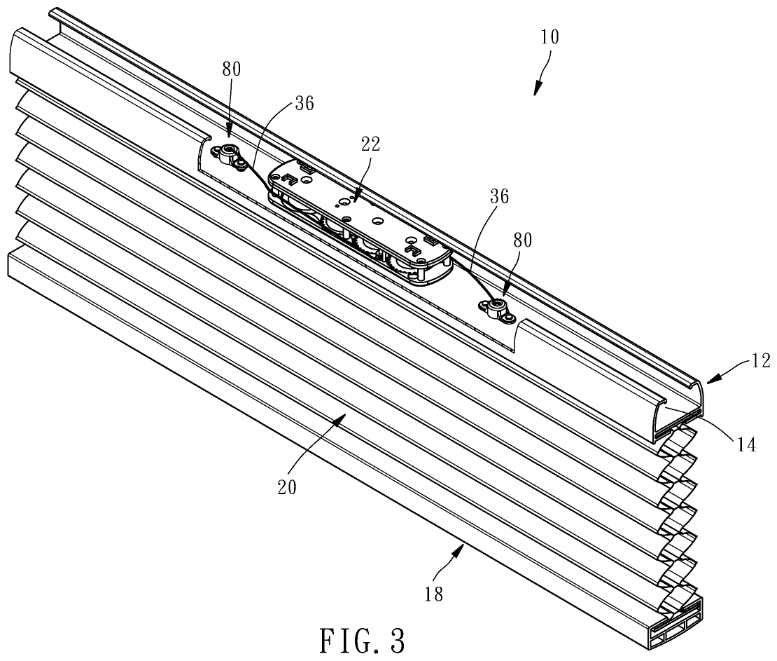

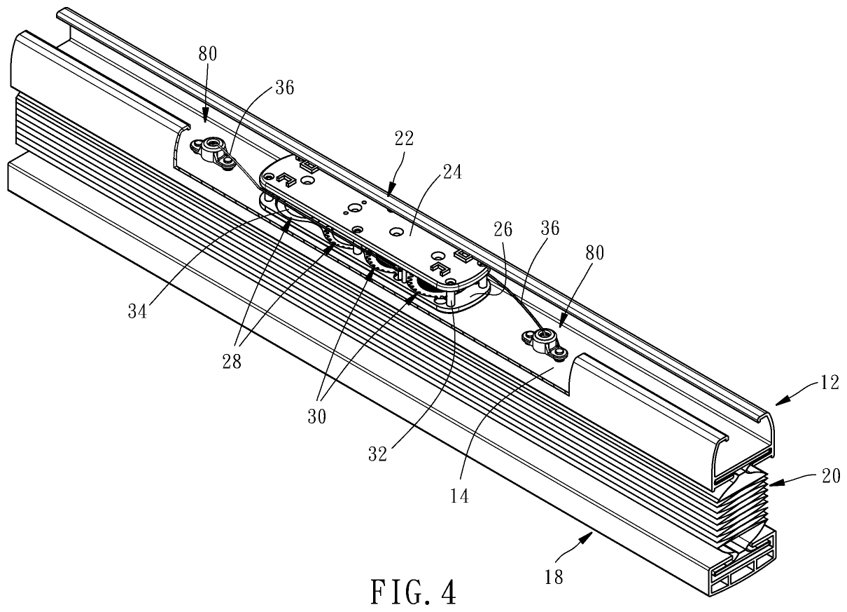

Please refer to FIG. 3 and FIG. 4. As shown in the drawings, a blind 10 comprises an upper beam 12, a lower beam 18, a blind sheet 20, a rope winder 22 and two lifting ropes 36.

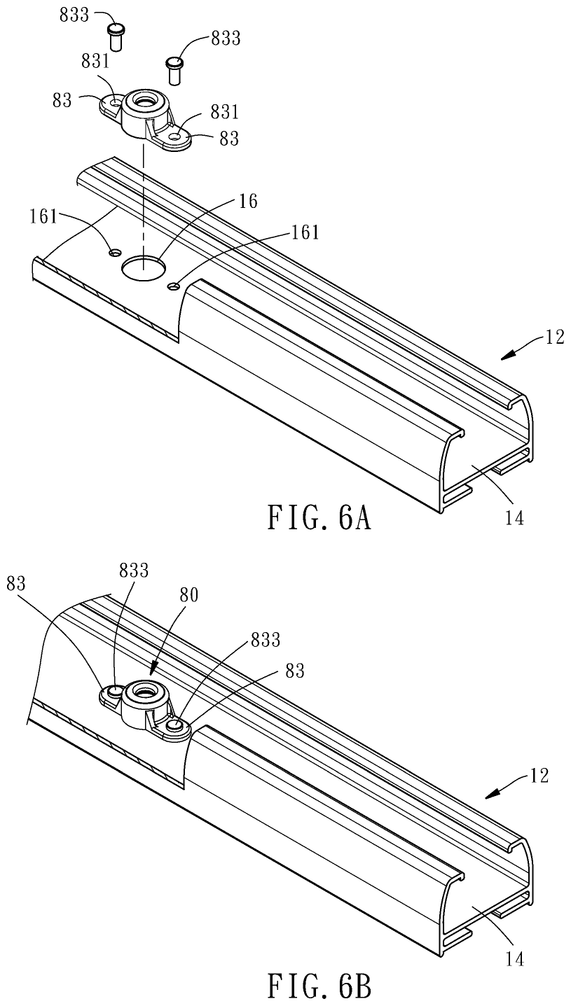

The upper beam 12 includes a bottom wall 14, and the bottom wall 14 includes two through holes 16 penetrating through the two top and bottom surfaces thereof (as shown in FIG. 6A and FIG. 6B). In addition, two sides of any one through hole 16 of the bottom wall 14 includes two sets of holes 161 penetrating through the two top and bottom surfaces thereof.

The blind sheet 20 (a honeycomb blind is used as an example for illustration; however, the present invention is not limited to such type only) is arranged between the upper beam 12 and the lower beam 18.

The rope winder 22 is arranged inside the upper beam 12 and includes a top plate 24, a bottom plate 26, two driving wheels 28 and two winding wheels 30. The top plate 24 and the bottom plate 26 utilize a plurality of supporting columns 32 disposed therebetween in order to be connected to each other. The two driving wheels 28 and the two winding wheels 30 are arranged parallel to each other and are engaged with each other in pairs, thereby achieving the effect of synchronous action with each other. In addition, a coil spring 34 is arranged between the two driving wheels 28. The two winding wheels 30 are connected to one ends of lifting rope 36 respectively, and another ends of the two lifting ropes 36 penetrate through the through hole 16 of the bottom wall 14 of the upper beam 12 and the blind sheet 20 in order to further connect to the lower beam 18. Accordingly, when the elastic restoring force provided by the coil spring 34 causes the two driving wheels 28 to rotate, the two driving wheels 28 are able to drive the two winding wheels 30 to rotate in order to allow the two lifting ropes 36 to be wound by the two winding wheels 30 such that the lower beam 18 is driven to move upward. During the process when the lower beam 18 moves upward, it is able to allow the blind sheet 20 to achieve the collapsing effect.

However, since each element of the aforementioned blind 10 is a known technique and is not the main features of the present invention, details thereof are omitted hereafter for the purpose of conciseness.

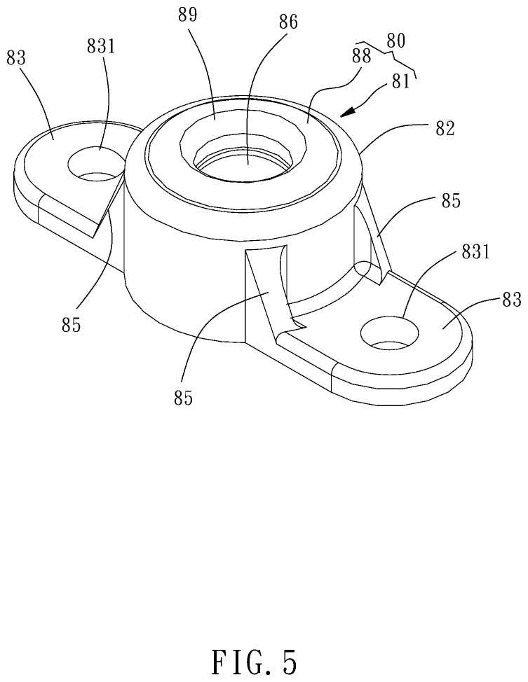

Please refer to FIG. 5. The stringing apparatus 80 according to the first embodiment of the present invention includes a plastic main body 81. The plastic main body 81 includes a circumferential wall 82 and two assembly wing 83 (its quantity can be increased to three or above three; however, it requires only one unit in practice). In addition, one ends of the two assembly wings 83 are respectively connected to the bottom end of the circumferential wall 82 of the plastic main body 81, and the two assembly wings 83 are arranged at two opposite sides of the circumferential wall 82. Furthermore, another end of any one of the assembly wings 83 penetrates through a set of attachment holes 831 penetrating through the two top and bottom surfaces. Moreover, any one of the assembly wings 83 and the circumferential wall 82 are connected to each other via two reinforcement ribs 85 disposed therebetween in order to reinforce connection strength between the circumferential wall 82 and the assembly wing 83. The center of the circumferential wall 82 includes a rope guiding hole 86 penetrating the two top and bottom surfaces thereof. In addition, the stringing apparatus 80 according to the first embodiment of the present invention further includes a ring member 88 made of a metal material. The ring member 88 includes a chamfer portion 89 surrounding a circumference of the rope guiding hole 86. With the chamber portion 89, the friction with the lifting rope 36 can be reduced in order to improve the smoothness of the action of the lifting rope 36.

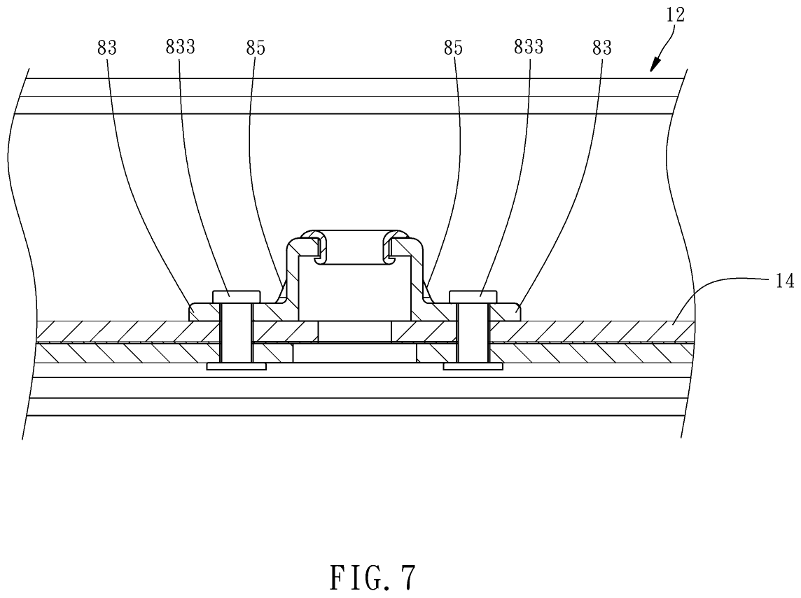

When the stringing apparatus 80 according to the first embodiment of the present invention is to be assembled onto the upper beam 12, as shown in FIG. 6A, FIG. 6B and FIG. 7, the two stringing apparatus 80 are installed onto the upper beam 12 and the bottom wall 14 in order to allow the rope guiding hole 86 of the plastic main body 81 of the two stringing apparatus 80 to be arranged at positions corresponding to the two through holes 16 respectively, such that the two lifting ropes 36 are able to penetrate through the two rope guiding holes 86 and the two corresponding through holes 16 respectively. Furthermore, the two sets of attachment holes 831 on the two assembly wings 83 are arranged at positions corresponding to the two sets of holes 161. At this time, two fasteners 833 are further used to penetrate into the set of attachment holes 831 and penetrate through the set of holes 161 for fastening. In the first embodiment of the present invention, examples of the fasteners 833 can be rivets or screw bolts etc.; however, the present invention is not limited to such types only.

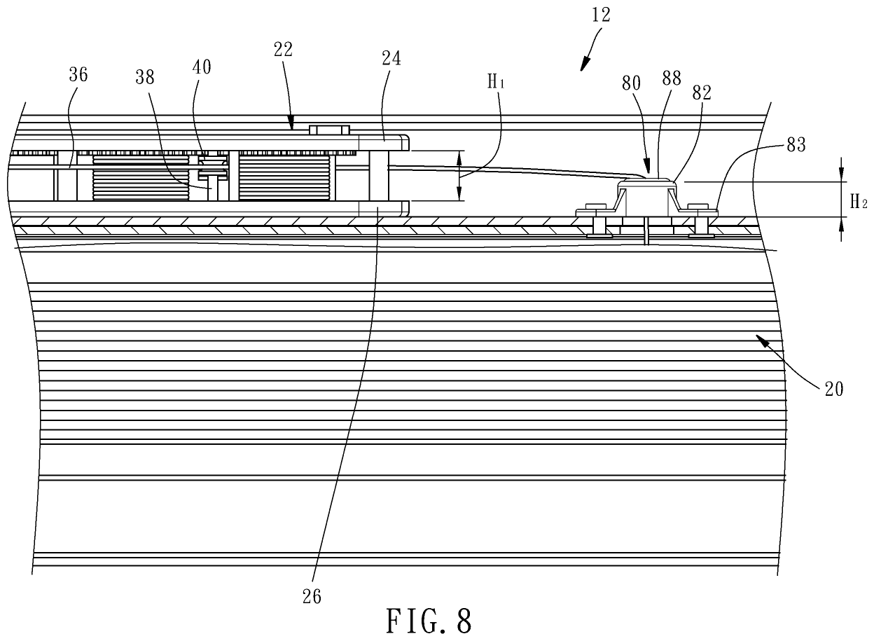

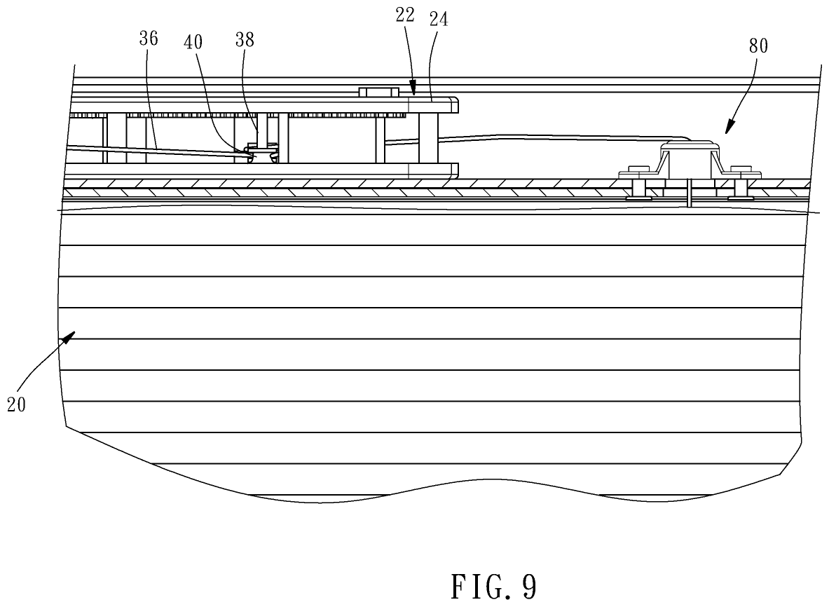

After the assembly is complete, as shown in FIG. 8 and FIG. 9, the relationship between the stringing apparatus 80 and the rope winder 22 satisfies the following relation: H₁:H₂=2-5:1; wherein H₁ refers a vertical distance between the bottom surface of the top plate 24 of the rope winder 22 and the top surface of the bottom plate 26 of the rope winder; H₂ refers to a vertical distance between the top surface of the circumferential wall 82 of the stringing apparatus 80 and the top surface of the bottom wall 14 of the upper beam 12. The most optimal ratio between H₁ and H₂ is 2:1.

In addition, to further increase the smoothness of the lifting rope 36 during the winding thereof, two guiding rods 38 are further installed between the top plate 24 and the bottom plate 26. The two guiding rods 38 are arranged between the two winding wheels 30 in a manner with their fronts and rears opposite from each other. Each guiding rod 38 is mounted with a guiding wheel 40 for guiding the lifting rope 36. Accordingly, when the lifting rope 36 is released from the winding wheel 30, i.e. during the deployment process of the blind sheet 20, the guiding wheel 40 is driven by the lifting rope 36 in order to move upward and downward along the axial direction of the guiding rods 38. Once the blind sheet 20 is fully deployed, as shown in FIG. 9, the guiding wheel 40 is located at the bottom end of the guiding rod 38 and abuts against the top surface of the bottom plate 26. On the contrary, when the lifting rope 36 is wound by the winding wheel 30, i.e. during the collapsing process of the blind sheet 20, the guiding wheel 40 is driven by the lifting rope 36 in order to move upward and downward along the axial direction of the guiding rod 38. Once the blind sheet 20 is fully collapsed, as shown in FIG. 8, the guiding wheel 40 is located at the top end of the guiding rod 38 and abuts against the bottom surface of the top plate 24.

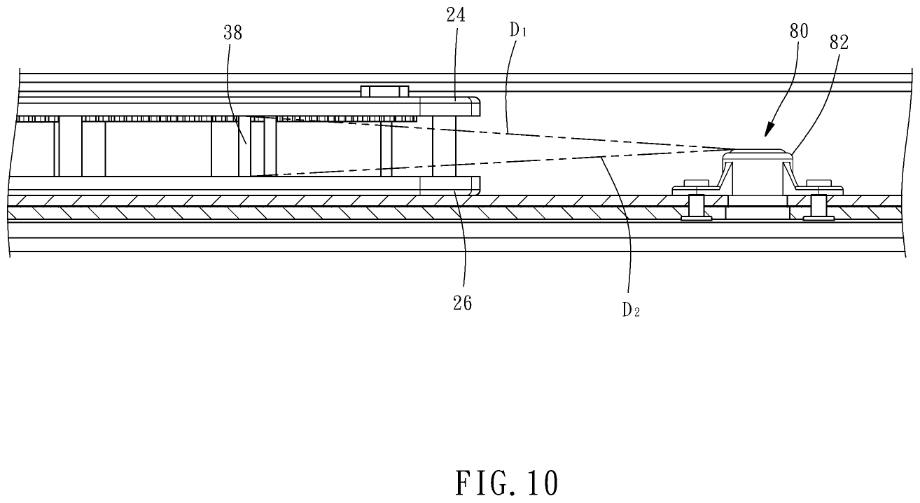

Furthermore, as shown in FIG. 10, the relationship between the stringing apparatus 80 and the rope winder 22 also satisfies another relation: D₁≅D₂; wherein D₁ refers to a distance from the top surface of the circumferential wall 82 of the stringing apparatus 80 to the intersection between the guiding rod 38 and the top plate 24; D₂ refers to a distance from the top surface of the circumferential wall 82 of the stringing apparatus 80 to the intersection between the guiding rod 38 and the bottom plate 26. Consequently, the relative positions among the three elements of the tope plate 24, bottom plate 26 and the circumferential wall 82 of the stringing apparatus 80 are in a relationship similar to an isosceles triangle. Nevertheless, it shall be noted that the guiding wheel 40 can be omitted according to the actual needs. For such configuration, the lifting rope 36 directly passes through the guiding rod 38 in order to be connected with the rope winder 30, and it moves upward and downward along the axial direction of the guiding rode 38 during the deployment and collapsing processes of the blind sheet 20.

In view of the above, the stringing apparatus 80 according to the first embodiment of the present invention is to utilize the ratio relationship of the height of the rope winder in order to allow the lifting rope 36 to be stably and smoothly wound by the winding wheel 30, and no interference or tangling of rope occurs among different loops of the lifting rope 36, thereby achieving the stable deployment and collapsing effect of the blind sheet 20. Furthermore, the stringing apparatus 80 of the present invention is not limited to be formed by the plastic main body 81 and the ring member 88, but can also be integrally formed with a wear-resistant material.

What is claimed is:

1. A stringing apparatus for a blind, said blind comprising an upper beam, a rope winder and a lifting rope; the upper beam having a bottom wall; the bottom wall having a through hole provided for the lifting rope to penetrate therethrough; the rope winder arranged inside the upper beam and having a top plate, a bottom plate and a winding wheel arranged between the top plate and the bottom; the lifting rope arranged on the winding wheel and configured to be driven by the winding wheel in order to wind the lifting rope thereon; the stringing apparatus arranged on the bottom wall of the upper beam; and the stringing apparatus having a circumferential wall, at least one assembly wing connected to the circumferential wall and a rope guiding hole provided for the lifting rope to penetrate therethrough; wherein a vertical distance between a bottom surface of the top plate of the rope winder and a top surface of the bottom plate of the rope winder is defined as H₁, and a vertical distance between a top surface of the stringing apparatus and a top surface of the bottom wall of the upper beam is defined as H₂, and a relationship between the two distances satisfies a relation of H₁:H₂=2-5:1.

2. The stringing apparatus for a blind according to claim 1, wherein the at least one assembly wing includes a set of attachment holes formed thereon.

3. The stringing apparatus for a blind according to claim 2, further comprising a reinforcement rib used for connecting to the at least one assembly wing and the circumferential wall.

4. The stringing apparatus for a blind according to claim 3, further comprising a plastic main body and a ring member; the plastic main body includes the circumferential wall; the ring member is mounted onto the circumferential wall of the plastic main body and surrounds a circumference of the rope guiding hole.

5. The stringing apparatus for a blind according to claim 1, wherein H₂ is a vertical distance between a top surface of the circumferential wall and the top surface of the bottom wall of the upper beam.

6. The stringing apparatus for a blind according to claim 2, wherein H₂ is a vertical distance between a top surface of the circumferential wall and the top surface of the bottom wall of the upper beam.

7. The stringing apparatus for a blind according to claim 3, wherein H₂ is a vertical distance between a top surface of the circumferential wall and the top surface of the bottom wall of the upper beam.

8. The stringing apparatus for a blind according to claim 4, wherein H₂ is a vertical distance between a top surface of the circumferential wall and the top surface of the bottom wall of the upper beam.

9. A blind, comprising:
a lower beam;
an upper beam having a bottom wall, and the bottom wall having a through hole;
a blind sheet arranged between the upper beam and the lower beam;
a rope winder arranged inside the upper beam and having a top plate, a bottom plate and a winding wheel arranged between the top plate and the bottom plate;
a lifting rope having one end penetrating through the through hole of the bottom wall of the upper beam and the blind sheet and further connected to the lower beam, and another end of the lifting rope connected to the winding wheel; and
a stringing apparatus arranged on the bottom wall of the upper beam and protruded out of a top surface of the bottom wall of the upper beam, and the stringing apparatus having a circumferential wall, at least one assembly wing connected to the circumferential wall and a rope guiding hole provided for the lifting rope to penetrate therethrough;
wherein a vertical distance between a bottom surface of the top plate of the rope winder and a top surface of the bottom plate of the rope winder is defined as H₁, and a vertical distance between atop surface of the stringing apparatus and a top surface of the bottom wall of the upper beam is defined as H₂, and a relationship between the two distances satisfies a relation of H₁:H₂=2-5:1.

10. The blind according to claim 9, wherein the bottom wall of the upper beam includes a set of holes, and the at least one assembly wing of the stringing apparatus includes a set of attachment holes corresponding to positions of the set of holes of the bottom wall of the upper beam; and a fastener penetrates into the set of attachment holes and also penetrates through the set of holes for fastening.

11. The blind according to claim 10, wherein the stringing apparatus includes a reinforcement rib used for connecting to the at least one assembly wing and the circumferential wall.

12. The blind according to claim 11, wherein the stringing apparatus includes a plastic main body and a ring member; the plastic main body includes the circumferential wall; the ring member is mounted onto the circumferential wall of the plastic main body and surrounds a circumference of the rope guiding hole.

13. The blind according to claim 9, wherein H₂ is a vertical distance between a top surface of the circumferential wall of the stringing apparatus and the top surface of the bottom wall of the upper beam.

14. The blind according to claim 10, wherein H₂ is a vertical distance between a top surface of the circumferential wall of the stringing apparatus and the top surface of the bottom wall of the upper beam.

15. The blind according to claim 11, wherein H₂ is a vertical distance between a top surface of the circumferential wall of the stringing apparatus and the top surface of the bottom wall of the upper beam.

16. The blind according to claim 12, wherein H₂ is a vertical distance between a top surface of the circumferential wall of the stringing apparatus and the top surface of the bottom wall of the upper beam.
